(19) United States
(12) Patent Application Publication
(10) Pub. No.: US 2025/0254106 A1
(43) Pub. Date: Aug. 7, 2025

(54) MACHINE LEARNING ORCHESTRATOR ENTITY FOR A MACHINE LEARNING SYSTEM

(71) Applicant: HUAWEI TECHNOLOGIES CO., LTD., Shenzhen (CN)

(72) Inventors: Miguel Angel GUTIERREZ ESTEVEZ, Munich (DE); Ramin KHALILI, Munich (DE); Apostolos KOUSARIDAS, Munich (DE); Ramya PANTHANGI MANJUNATH, Munich (DE); Jose Mauricio PERDOMO, Munich (DE)

(21) Appl. No.: 19/191,645

(22) Filed: Apr. 28, 2025

Related U.S. Application Data
(63) Continuation of application No. PCT/EP2022/080366, filed on Oct. 31, 2022.

(51) Int. Cl. H04L 41/16; H04L 41/0806; H04L 41/14

(52) U.S. Cl. CPC H04L 41/16; H04L 41/0806; H04L 41/14

(57) ABSTRACT

The present disclosure relates to a machine learning (ML) orchestrator entity for a ML system. The ML system comprises one or more local learning agents (LLAs) and is configured to compute an analytics output for an analytics service. The ML orchestrator entity comprises first processing circuitry configured to: receive an analytics service request for the analytics service from a consumer entity; define a ML profile for the analytics service based on the analytics service request; and determine ML job information based on the ML profile, wherein the ML job information indicates, for each LLA of the one or more LLAs, a computation operation to be performed by that LLA to compute the analytics output.

### CROSS-REFERENCE TO RELATED APPLICATIONS

This application is a continuation of International Application No. PCT/EP2022/080366, filed on Oct. 31, 2022, the disclosure of which is hereby incorporated by reference in its entirety.

### TECHNICAL FIELD

The present disclosure relates to a machine learning orchestrator entity for a machine learning system. This disclosure proposes a ML system configured to compute an analytics output for an analytics service. The disclosure also provides a method for computing an analytics output for an analytics service.

### BACKGROUND

Different types of network data analytics services have been specified in 5th generation (5G) mobile communication networks (e.g., Quality of Service (QOS) sustainability, network performance information, User Equipment (UE) mobility information). The Network Data Analytics Function (NWDAF) is the entity that has been specified by 3GPP in 5G communication systems to provide data analytics to network functions, Operations, Administration and Maintenance (OAM), Application Functions (AFs) etc., by using Machine Learning (ML) models. Analytics information are either statistical information of the past events, or predictive information. Current solutions lack flexibility to deploy a required configuration or ML technique of ML models that meet the different heterogeneous requirements or desired technique requested by the consumer.

### SUMMARY

It is an objective of this disclosure to extend learning procedures for any type of privacy requirements, data distribution, energy consumption and/or any other constraint that one or more local learning agents (LLAs) might have. Another objective of this disclosure is to automatize a selection, e.g., a deployment and configuration, of a learning procedure. It is further an objective of this disclosure to unify, harmonize, generalize and/or extend current distributed ML techniques such as Federated Learning (FL), Split Learning (SL), Federated Distillation (FD), Hierarchical FL (HFL) or any distributed ML technique that can be described as a Directed Acyclic Graph (DAG).

These and other objectives are achieved by the solutions of this disclosure as described in the independent claims. Advantageous implementations are further defined in the dependent claims.

A first aspect of this disclosure provides a machine learning, ML, orchestrator entity for a ML system comprising one or more local learning agents, LLAs, configured to jointly compute an analytics output for an analytics service, wherein the ML orchestrator entity comprises first processing circuitry configured to: receive an analytics service request for the analytics service from a consumer entity; define a ML profile for the analytics service based on the analytics service request; and determine ML job information based on the ML profile, wherein the ML job information indicates, for each LLA of the one or more LLAs, a computation operation to be performed by that LLA to compute the analytics output.

The ML job information may further comprise information on a connection between two or more LLAs.

The ML orchestrator entity may be an entity in charge of deciding and coordinating an execution of the ML job information. The ML job information may comprise information on an execution of a ML technique as the indication of the computation operation. The ML technique may be used to build a ML model. The ML orchestrator entity may be an entity in charge of communicating the ML job information to the one or more LLAs. The one or more LLAs may be nodes involved in a learning process.

The consumer entity may be a consumer of the analytics service. The consumer entity may be one or more LLA, the ML orchestrator entity or any other entity not involved in the analytics service. A LLA involved in the learning process of a particular analytics service may be referred to as a contributor.

A ML technique may be a particular distributed machine learning procedure such as FL or SL. A ML profile may be a list of inputs, such as requirements and/or constraints of LLAs, and/or data that is necessary to define a ML job graph. The ML profile may be defined by the analytics service request and/or by constraints of the one or more LLAs involved in the analytics service, e.g. privacy, energy, communication capabilities, or others.

A data set may be a list of samples and their features that are useful for a particular analytics service. A sample may be an element of a data set. A feature may be an element of a sample. The analytics service may comprise one or more computation operations.

The ML orchestrator entity of this disclosure may, for example, be implemented in a NWDAF and/or a next generation Node B (gNB).

Advantageously an extension of the ML profile considering requirements and/or constraints of each LLA, for example privacy requirements, computational capacity and/or energy, may enable a combination of capabilities, capacities, target energy saving requirements, target privacy requirements and/or target load requirements of each LLA with a target ML performance.

In an embodiment, the first processing circuitry is configured to define the ML profile for the analytics service further based on one or more LLA constrains.

The LLA constraints may for example be capabilities, capacities, target energy saving requirements, target privacy requirements, target load requirements, communication requirements, and/or memory requirements.

In an embodiment, the ML job information comprises interface configuration information, wherein the interface configuration information indicates from which LLA of the one or more LLAs each LLA of the one or more LLAs is configured to receive a partial analytics output, and to which LLA of the one or more LLAs each LLA of the one or more LLAs is configured to send a partial analytics output.

In an embodiment, the ML orchestrator entity is further configured to determine if the ML job information for the ML profile already exists, and if the ML job information exists, the ML orchestrator entity is configured to retrieve the existing ML job information, and if the ML job information does not exist, the ML orchestrator entity is configured to create the ML job information based on the ML profile.

In an embodiment, the ML orchestrator entity is configured to communicate to each LLA of the one or more LLAs information indicating the computation operation to be performed by that LLA according to the ML job information.

In an embodiment, the ML orchestrator entity is configured to compute a ML job graph as the ML job information, wherein the ML job graph defines a set of parameters and corresponding functions related to the computation operation for each LLA of the ML system.

The ML job graph may be a computational graph describing a function to be computed at each LLA. The ML job graph may be a computational graph describing a communication flow between two or more LLAs to generate an output.

Advantageously computing the ML job graph by means of the ML orchestrator entity across LLA agents, according to the ML profile enables an automatization of a selection and a realisation of an appropriate ML deployment configuration. This may lead to a faster, a cheaper and a more scalable ML management.

Advantageously the ML job graph may specify on demand features of each LLA. The features may for example be model parameters, input features, partial computations and/or partial outputs. The specification of features of each LLA may define an overall ML model behaviour.

Advantageously a flexible and dynamic specification of a ML model is achieved that may fit to each requirement and/or constraint of involved LLAs, for example data producer, and involved consumers.

In an embodiment, the ML orchestrator entity is configured to collaborate with the one or more LLAs to compare a performance of the analytics output for the analytics service with an expected performance.

In an embodiment, the ML orchestrator entity is configured to determine based on the compared performance whether a training or retraining of the ML profile is needed, and to redefine the ML profile for the analytics service if the training or the retraining is needed.

ML model parameters of the ML profile may for example be: learning rate, type of optimizer, weights and biases in a Neural Network (NN)-based method and/or splitting points in a Tree-based method.

In an embodiment, the analytics service request from the consumer entity comprises an analytics ID of the analytics service, and/or a requested ML model accuracy for the analytics service, and/or a requested ML technique for the analytics service.

In an embodiment, the ML orchestrator entity is configured to trigger a training operation or a retraining operation of a ML model of the ML profile at one or more of the one or more LLAs for the analytics service based on at least one of the following information: one or more LLA IDs, each LLA ID indicating a LLA for computing their analytics output for the analytics service; a type of the analytics service; an expected analytics performance based on the requested ML model accuracy; a preferred ML technique for computing the analytics output; data available at the one or more LLAs.

The ML profile may be defined based on the analytics service. Further, the ML profile may be defined based on the one or more LLA IDs, each LLA ID indicating a LLA for computing their analytics output for the analytics service, the type of the analytics service, the expected analytics performance based on the requested ML model accuracy, the preferred ML technique for computing the analytics output and/or the data available at the one or more LLAs.

The ML profile may for example be a combination of the Analytics identifier (ID), e.g. QoS prediction, with the LLA requirements and/or LLA constraints, e.g. privacy requirements.

In an embodiment, the ML orchestrator entity is further configured to register the one or more LLAs in association with an analytics ID of the analytics service, wherein the ML orchestrator entity is configured to receive a registration message from each LLA of the one or more LLAs, the registration message comprising at least one of the following information: a LLA ID of the LLA, data available at the LLA, one or more constraints of the LLA.

A second aspect of this disclosure provides a local learning agent, LLA, for a machine learning, ML, system, the LLA comprising second processing circuitry configured to: receive ML job information indicating a computation operation to be performed by the LLA; perform the computation operation based on the received ML job information to compute an analytics output for an analytics service; and output the analytics output to a ML orchestrator entity or another LLA.

Advantageously the LLA supports a dynamic configuration and/or adaptation of a role of each LLA involved in the analytics service, e.g., base station (BS), UE and/or NWDAF, for a ML model configuration, according to constraints and/or requirements, e.g. privacy, performance and/or computational, increasing a 5G and/or B5G ML framework flexibility.

In an embodiment, the LLA is configured to train or retrain a ML model of a ML profile for the analytics service based on at least one of the following information: one or more LLA IDs, each LLA ID indicating a LLA for computing their analytics output for the analytics service; a type of the analytics service; an expected analytics performance based on a requested ML model accuracy; a preferred ML technique for computing the analytics output; local input available at the one or more LLAs.

In an embodiment, the LLA is configured to determine based on a compared performance whether a retraining of a ML profile defined by the ML orchestrator entity is needed, and inform the ML orchestrator entity accordingly.

In an embodiment, the LLA is configured to receive one or more inputs from other LLAs, each input comprising a partial analytics output for the analytics service; and/or the LLA is configured to compute the analytics output further based on one or more local inputs.

A third aspect of this disclosure provides an aggregator local learning agent, LLA, for a machine learning, ML, system, the aggregator LLA comprising third processing circuitry configured to: aggregate one or more partial analytics outputs from one or more LLAs to obtain an analytics output, and output the analytics output to a machine learning, ML, orchestrator entity.

The aggregated analytics output may be a combination of information from one or more LLAS.

A fourth aspect of this disclosure provides a machine learning, ML, system configured to compute an analytics output for an analytics service, the ML system comprising a ML orchestrator entity according to the first aspect of this disclosure; and one or more LLAs according to the second aspect of this disclosure.

In an embodiment, the ML system further comprises an aggregator LLA according to the third aspect of this disclosure.

In an embodiment, the ML system further comprises one or more first interfaces between the ML orchestrator entity and the one or more LLAs, the ML orchestrator entity being configured to send the ML job information to the one or more LLAs over the one or more first interfaces.

In an embodiment, the ML system further comprises one or more second interfaces between the one or more LLAs, wherein at least a first LLA of the one or more LLAs is configured to receive one or more partial analytics outputs from one or more second LLAs of the one or more LLAs, and/or send a partial analytics output to the one or more second LLAs.

A fifth aspect of this disclosure provides a method for a machine learning, ML, orchestrator entity for a ML system comprising one or more local learning agents, LLAs, configured to compute an analytics output for an analytics service, the method being performed by the ML orchestrator entity and comprising: receiving an analytics service request for the analytics service from a consumer entity; defining a ML profile for the analytics service based on the analytics service request; and determining ML job information based on the ML profile, wherein the ML job information indicates, for each LLA of the ML system, a computation operation to be performed by that LLA to compute the analytics output.

A sixth aspect of this disclosure provides a computer program comprising instructions which, when the computer program is executed by a fourth processing circuitry, cause the fourth processing circuitry to perform the method according to the fifth aspect of this disclosure.

The solutions of the present disclosure are not limited to the examples described above. The solutions of the present disclosure may for example also be implemented in Institute of Electrical and Electronics Engineers (IEEE) networks such as 802.11. The solutions of the present disclosure may for example also be implemented in cluster servers that are aimed at keeping data privacy among entities. Further the solutions of the present disclosure may for example also be implemented in the context of applications. For example, for applications requiring standard FL or SL, hierarchical FL, or any other learning procedure whose job graph can be represented as a directed acyclic graph.

### BRIEF DESCRIPTION OF DRAWINGS

The above described aspects and implementation forms will be explained in the following description of specific embodiments in relation to the enclosed drawings, in which

FIG. 1 shows a ML system comprising a ML orchestrator entity and a LLA according to an embodiment of this disclosure.

FIG. 2 shows a ML system comprising a ML orchestrator entity a LLA and an aggregator LLA according to an embodiment of this disclosure.

FIG. 3 illustrates a method for message exchange between involved entities in a ML system according to an embodiment of this disclosure.

FIG. 4 illustrates a ML job graph according to an embodiment of this disclosure.

FIG. 5 illustrates a method for message exchange between involved entities in a ML system according to an embodiment of this disclosure.

FIG. 6 illustrates a method for message exchange between involved entities in a ML system according to an embodiment of this disclosure.

FIG. 7 illustrates the difference between a vertical data split and a horizontal data split according to an embodiment of this disclosure.

FIG. 8 illustrates a ML job graph according to an embodiment of this disclosure.

FIG. 9 illustrates a method for message exchange between involved entities in a ML system according to an embodiment of this disclosure.

FIG. 10a shows a horizontal data split according to an embodiment of this disclosure.

FIG. 10b illustrates a ML job graph according to an embodiment of this disclosure.

FIG. 11 shows a method for a ML orchestrator entity according to an embodiment of this disclosure.

### DETAILED DESCRIPTION OF EMBODIMENTS

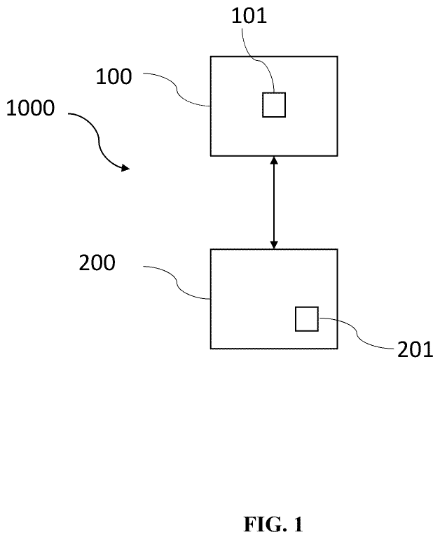

FIG. 1 shows a ML system 1000 comprising a ML orchestrator entity 100 and a LLA 200 according to an embodiment of this disclosure.

The ML system 1000 may comprise the ML orchestrator entity 100 and a LLA 200. The LLA 200may be configured to compute an analytics output for an analytics service. The ML orchestrator entity 100 may comprise first processing circuitry 101. The first processing circuitry 101 may be configured to receive an analytics service request for the analytics service from a consumer entity. Further the first processing circuitry 101 may be configured to define a ML profile for the analytics service based on the analytics service request. The first processing circuitry 101 may also be configured to determine ML job information based on the ML profile, wherein the ML job information indicates, for each LLA 200 of the one or more LLAs 200, a computation operation to be performed by that LLA 200 to compute the analytics output.

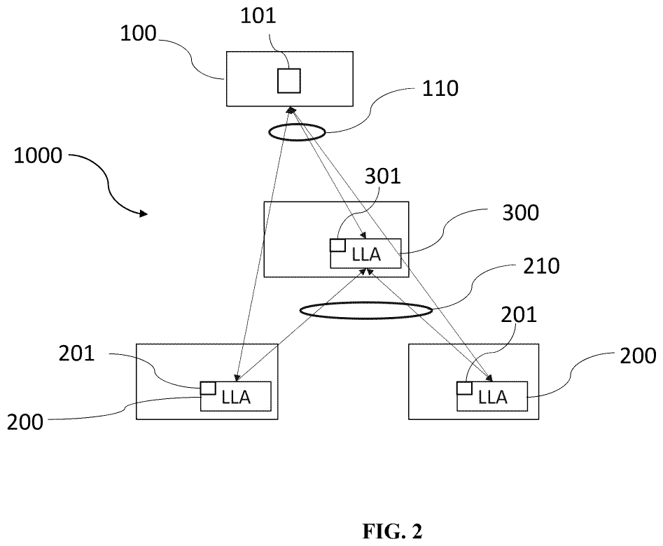

FIG. 2 shows a ML system 1000 comprising a ML orchestrator entity 100, a LLA 200 and an aggregator LLA 300 according to an embodiment of this disclosure.

The ML system 1000 shown in FIG. 2 may be configured to compute an analytics output for an analytics service. The ML system 1000 may comprise a ML orchestrator entity 100 and one or more LLAs 200. The ML system 1000 may further comprise an aggregator LLA 300.

As shown in FIG. 2, the ML system 1000 may further comprise one or more first interfaces 110 between the ML orchestrator entity 100 and the one or more LLAs 200. The ML orchestrator entity 100 may be configured to send ML job information to the one or more LLAs 200 over the one or more first interfaces 110.

Further as shown in FIG. 2, the ML system 1000 may also comprise one or more second interfaces 210 between the one or more LLAs 200. At least a first LLA 200 of the one or more LLAs 200 may be configured to receive one or more partial analytics outputs from one or more second LLAs 200 of the one or more LLAs 200, and/or send a partial analytics output to the one or more second LLAs 200.

Similar to the embodiment shown in FIG. 1, the one or more LLAs 200shown in FIG. 2 may also be configured to compute an analytics output for an analytics service. The ML orchestrator entity 100 shown in FIG. 2 may comprise first processing circuitry 101. The first processing circuitry 101 may be configured to receive an analytics service request for the analytics service from a consumer entity. Further the first processing circuitry 101 may be configured to define a ML profile for the analytics service based on the analytics service request. The first processing circuitry 101 shown in FIG. 2 may also be configured to determine ML job information based on the ML profile, wherein the ML job information comprises, for each LLA 200 of the one or more LLAs 200, a computation operation to be performed by that LLA 200 to compute the analytics output. The first processing circuitry 101 shown in FIG. 2 may be configured to define the ML profile for the analytics service further based on one or more LLA 200 constrains.

The ML job information may comprise interface configuration information. The interface configuration information may indicate from which LLA 200 of the one or more LLAs 200 each LLA 200 of the one or more LLAs 200 may be configured to receive a partial analytics output. The interface configuration information may further indicate to which LLA 200 of the one or more LLAs 200 each LLA 200 of the one or more LLAs 200 may be configured to send a partial analytics output.

The ML orchestrator entity 100 shown in FIG. 2 may further be configured to determine if the ML job information for the ML profile already exists. If the ML job information exists, the ML orchestrator entity 100 may be configured to retrieve the existing ML job information. The ML orchestrator entity one hundred may for example retrieve the existing ML job information from a data base. If the ML job information does not exist, the ML orchestrator entity 100 may be configured to create the ML job information based on the ML profile.

Furthermore, the ML orchestrator entity 100 shown in FIG. 2 may be configured to communicate to each LLA 200 of the one or more LLAs 200 information indicating the computation operation to be performed by that LLA 200 according to the ML job information. The ML orchestrator entity 100 may also be configured to compute a ML job graph 400 as the ML job information. The ML job graph 400 may define a set of parameters and corresponding functions related to the computation operation for each LLA 200 of the ML system 1000.

The ML orchestrator entity 100 shown in FIG. 2 may further be configured to collaborate with the one or more LLAs 200 to compare a performance of the analytics output for the analytics service with an expected performance. The ML orchestrator entity 100 may be configured to determine based on the compared performance whether a training or a retraining of the ML profile is needed, and to redefine the ML profile for the analytics service if the training or the retraining is needed.

The analytics service request from the consumer entity may comprise an analytics ID of the analytics service, and/or a requested ML model accuracy for the analytics service, and/or a requested ML technique for the analytics service.

The ML orchestrator entity 100 shown in FIG. 2 may be configured to trigger a training operation and/or a retraining operation of a ML model of the ML job graph at one or more of the one or more LLAs 200 for the analytics service. The training operation and/or the retraining operation may be based on at least one of the following information: one or more LLA 200 IDs, each LLA 200 ID indicating a LLA 200 for computing their analytics output for the analytics service; a type of the analytics service; an expected analytics performance based on the requested ML model accuracy; a preferred ML technique for computing the analytics output; and/or data available at the one or more LLAs 200.

The ML orchestrator entity 100 shown in FIG. 2 may further configured to register the one or more LLAs 200 in association with the analytics ID of the analytics service. The ML orchestrator entity 100 may be configured to receive a registration message from each LLA 200 of the one or more LLAs 200. The registration message may comprise at least one of the following information: a LLA 200 ID of the LLA 200, data available at the LLA (200), and/or one or more constraints of the LLA 200.

As shown in FIG. 2 the one or more LLAs 200 may comprise second processing circuitry 201 configured to receive ML job information indicating a computation operation to be performed by the LLA 200. The second processing circuitry 201 may further be configured to perform the computation operation based on the received ML job information to compute an analytics output for an analytics service. The second processing circuitry 201 may also be configured to output the analytics output to a ML orchestrator entity 100 or another LLA 200.

The one or more LLAs 200 shown in FIG. 2 may be configured to train or retrain a ML model of a job graph for the analytics service based on at least one of the following information: one or more LLA 200 IDs, each LLA 200 ID indicating a LLA 200 for computing their analytics output for the analytics service; a type of the analytics service; an expected analytics performance based on a requested ML model accuracy; a preferred ML technique for computing the analytics output; and/or local input available at the one or more LLAs 200.

The one or more LLAs 200 shown in FIG. 2 may further be configured to determine based on a compared performance whether a retraining of a ML profile defined by the ML orchestrator entity 100 is needed, and inform the ML orchestrator entity 100 accordingly. The one or more LLAs 200 may be configured to receive one or more inputs from other LLAs 200. Each input may comprise an analytics output for the analytics service, and/or

The one or more LLAs 200 may also be configured compute its partial analytics output further based on one or more local inputs.

The aggregator LLA 300 may comprise third processing circuitry 301. The third processing circuitry 301 may be configured to aggregate one or more partial analytics outputs from one or more LLAs 200 to obtain the analytics output. The third processing circuitry 301 may also be configured to output the analytics output to the ML orchestrator entity 100.

The ML orchestrator entity 100 may, for example, be in charge of deciding and coordinating the learning procedure among involved LLAs 200. The ML orchestrator entity 100 may have access to the involved LLAs 200 that may potentially take part in the analytics service. The ML orchestrator entity 100 may also have access to constraints of the involved LLAs 200, for example privacy requirements and/or computational capabilities. With the information described above, and upon an analytics service request from the consumer entity, the ML orchestrator entity 100 may be able to define a ML technique that better suits the analytics service. The ML technique may for example be FL, or SL. The ML orchestrator entity 100 may then communicate each LLA 200 its job, i.e., what local inputs to use, from which LLAs 200 they receive outputs from, what LLAs 200 they send their outputs to, and a function to generate their outputs from their local inputs and partial outputs from other LLAs 200.

One or more LLAs 200 may be configurable by the ML orchestrator entity 100. The one or more LLAs 200 may register as contributors of a particular analytics ID with the ML orchestrator entity 100 by providing their available local information as well as their constraints. When the one or more LLAs 200 receive their ML job information for the analytics service from the ML orchestrator entity 100, the one or more LLAs 200 may configure the second interfaces 210 to receive partial outputs from other LLAs 200 and forward their partial outputs to other LLAs 200.

The first interface 110 may also be referred to as a ML orchestrator-LLA interface. The first interface 110 may be configured to distribute the ML job graph 400 generated at the ML orchestrator entity 100 to one or more LLAs 200. The first interface 110 may further be configured to send ML job information, e.g. message content, of one or more LLAs 200. The second interface 210 may also be referred to as a LLA-LLA interface. The second interface 210 may be configured to enable one or more LLAs 200 to receive partial outputs from other LLAs 200 and to send partial outputs to other LLAs 200 involved in the analytics service.

Advantageously, with the above described features, it is possible to extend learning procedures for any type of privacy requirements, data distribution, energy consumption and/or any other constraint that one or more LLAs might have.

Advantageously, with the above described features, it is further possible to automatize a selection, i.e. a deployment and configuration, of the learning procedure.

Furthermore, with the above described features, it is possible to unify, harmonize, generalize and/or extend current distributed ML techniques such as FL, SL, FD, HFL or any distributed ML technique that can be described as a DAG.

Characteristics of supported ML techniques may, amongst others, be the following:
One or more LLAs 200 may be clustered in levels;
Each level 401, 402 and 403 of the ML system 1000, except the last level, preferably an aggregator level 403, may have more than one LLA 200;
The last level, preferably the aggregator level 403, may have one LLA 200;
The aggregator level 403 may be in charge of generating the output of a distributed algorithm and sending the output to the ML orchestrator entity 100;
For a forward computation, for example a function execution, a communication may flow from lower-level LLAs 200 to higher-level LLAs 200 up to the aggregator LLA 300;
For a backward computation, for example a function update, the communication may flow from higher-level LLAs 200 to lower-level LLAs 200.

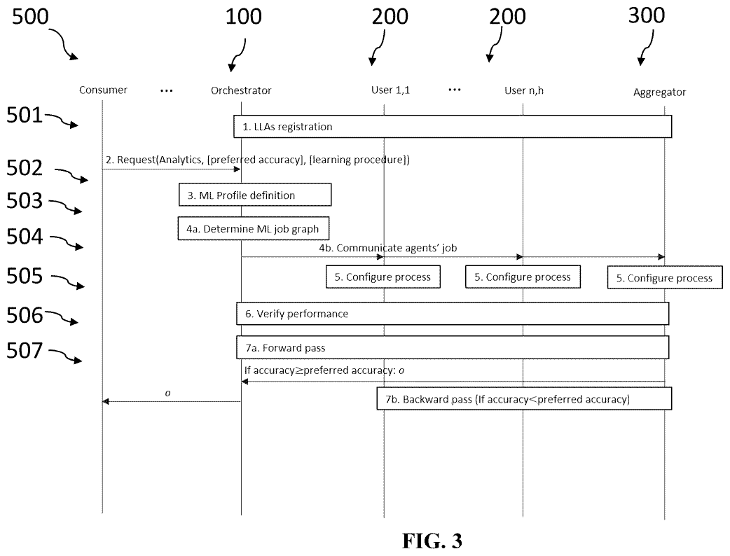

FIG. 3 illustrates a method 500 for message exchange between involved entities in a ML system 1000 according to an embodiment of this disclosure.

The method 500 for message exchange for an establishment of an analytics service and for an execution of the analytics service may comprise the following operations:

The method 500 may comprise an operation 501 of registering one or more LLAs 200. Each LLA 200 that may be eligible for a particular analytics ID may be registered with the ML orchestrator entity 100 before an analytics service request arrives at the ML orchestrator entity 100. A registration message may be sent from the one or more LLAs to the ML orchestrator entity 100 through a first interface 110. The registration message may comprise but is not limited to: LLA ID, Analytics ID, data available and/or constraints, for example data privacy and/or computational capacity.

The method 500 may further comprise an operation 502 of request reception. The ML orchestrator entity 100 may receive the analytics service request from a consumer. The consumer may comprise information indicating the Analytics ID. The consumer may further comprise information indicating a preferred accuracy and/or a preferred ML technique.

The method 500 may also comprise an operation 503 of creating a ML profile. The ML orchestrator entity 100 may create the ML profile for providing the analytics service using at least one of the following information:
ID of eligible LLAs 200;
Type of ML task, for example classification or regression;
Analytics performance based on a preferred accuracy if provided by the consumer;
Preferred ML technique if provided by the consumer;
Data available at the eligible LLAs 200;
Constraints of eligible LLAs 200;
Latency requirements for generation of an output of the analytics ID.

The method 500 may comprise an operation 504 of determining a ML job graph 400. Given a ML profile, the ML orchestrator entity 100 may first determine if a ML job graph 400 exists that fits the ML profile. If the ML job graph 400, that is the ML job information, exists, the ML orchestrator entity 100 may be configured to retrieve the existing ML job information, and if the ML job graph 400, that is the ML job information, does not exist, the ML orchestrator entity 100 may be configured to create the ML job information based on the ML profile.

The ML orchestrator entity 100 may then send a local job message to each LLA 200 communicating their corresponding local job, derived from the ML job graph through the first interface 110. The local job message from the ML orchestrator entity 100 to each LLA 200 may contain the following information: analytics ID, function to compute, inputs coming from other LLAs 200, inputs related to local data, and information on where to send the output.

The local job of each LLA may be shared in the form of a container program such as a Docker, or in the form of a formatted file, listing all the necessary information to build the function such as a ML model type. The ML model type may for example be one of, but is not limited to, the following: Convolutional Neural Network (CNN), Feed-Forward Neural Network (FFNN), Recurrent Neural Networks (RNN) such as Long-Short Time Memory Network (LSTM), Transformers, Graph Neural Network (GNN), or other non-differentiable learning methods such as Tree-based methods like Random Forest (RF), LightGBM, XGBoost, and/or CatBoost. A value of each parameter of the ML model may for example be one of, but is not limited to, the following: learning rate, type of optimizer, weights and biases in a NN-based method, and/or splitting points in a Tree-based method. A feature calculation for preprocessing input data may for example be: exponential Moving Average (EMA), and/or one-hot encodings of canonical data, and/or embeddings for a preprocessing of text, and/or video, and/or audio, and/or actions.

The method 500 may comprise an operation 505 of LLA job configuration. Each LLA 200 may configure internal ML processes after receiving ML job information from the ML orchestrator entity 100.

The method 500 may comprise an operation 506 of performance verification. The one or more LLAs 200, along with the ML orchestrator entity 100, may jointly verify an expected performance of the ML task and identify if retraining is needed.

The method 500 may comprise an operation 507 of task execution. The ML task may be performed by one or more LLAs 200 each receiving inputs from other LLAs 200. Each LLA 200 may compute its output based on a local function, and may for its output for inference and/or training. If a configuration of the learning procedure is inference, the aggregator LLA 300 may send its output to the ML orchestrator entity 100. The ML orchestrator entity 100 may forward its output to the consumer.

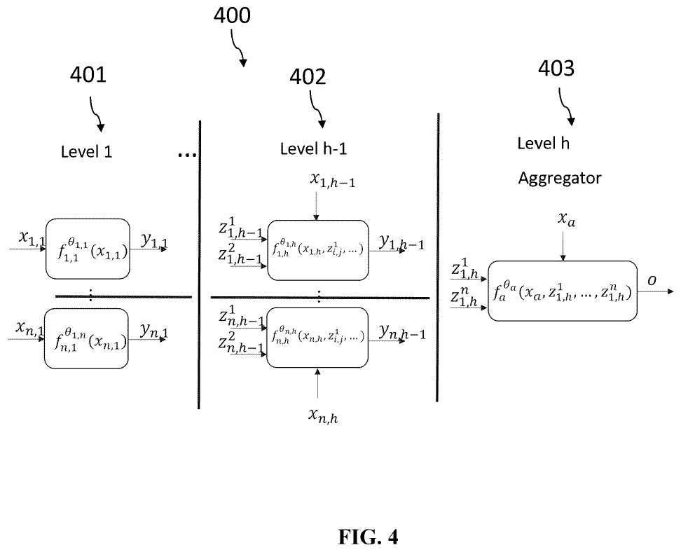

FIG. 4 illustrates a ML job graph 400 according to an embodiment of this disclosure.

The ML job graph 400 may be computed at the ML orchestrator entity 100 based on the ML profile. In this way, a selection of a ML technique may be automatized and/or optimized according to the ML task at hand, together with LLA constraints.

A ML job graph, given the ML profile, may determine one or more of the following:
AI/ML model to be used for the analytics service;
Role, level and/or connections of each LLA 200;
Distribution of the ML task across the one or more LLAs 200, for example, what part of the model may be computed at which LLA 200 of the one or more LLAs 200;
Which inputs each LLA 200 may use, for example local data and/or outputs from other LLAs 200, and/or to which LLA 200 of the one or more LLAs 200 intermediate outputs of the one or more LLAs 200 may be forwarded.

The ML job graph 400 may be defined by the following parameters:
f_{(i,j)}^{θ(i,j)}: function at node i of level j parametrized by model parameters θ(i,j);
x_(i,j) and y_(i,j): input and output features at node i of level j, respectively;
z_{(i,j)}^{k}: input k at node i of level j, related to an output of a node at node i of level j−1;
o: output of the ML model generated at the aggregator node.

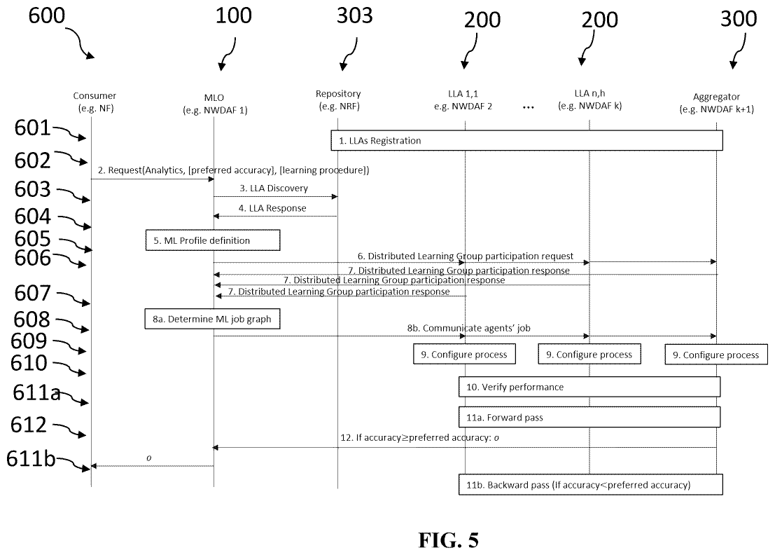

FIG. 5 illustrates a method 600 for message exchange between involved entities of a ML system 1000 according to an embodiment of this disclosure.

For example, the ML orchestrator entity 100 may be implemented in a NWDAF of a 3rd generation (3G) Partnership Program (3GPP) core network. The one or more LLAs 200 may be other NWDAFs or any other NF with private data that may not be exchanged with the ML orchestrator entity 100.

According to another example the ML orchestrator entity 100 may be an Analytics Logical Function (AnLF), which may be an inference function of an NWDAF. The one or more LLAs 200 may be a Model Training Logical Function (MTLFs), which may be a training function of NWDAFs.

For example, an aggregator LLA 300 may be another NF such as another NWDAF. According to a further example the aggregator LLA 300 may be a NWDAF acting as ML orchestrator entity 100 in a case in which the ML orchestrator entity 100 has relevant data for an Analytics ID and thus may also be a LLA 200.

The example shown in FIG. 5 may comprise a repository entity 303, for example a Network Repository Function (NRF). The repository entity 303 may collect registration information of one or more LLAs 200 that may be involved in a particular Analytics ID.

The method 600 may comprise one or more of the following operations:

First, the ML orchestrator entity 100 may register (operation 601) the one or more LLAs 200 in association with an analytics ID of the analytics service.

After a NF in the form of a consumer sends an analytics service request to the ML orchestrator entity 100 (operation 602), the ML orchestrator entity 100 may contact the repository entity 303 for LLA discovery (operation 603).

The Repository may reply with a discovery response including information regarding available LLAs 200, their data, and their constraints (operation 604).

With this information, the ML orchestrator entity 100 may define a ML profile (operation 605), and may optionally send a request for a creation of a distributed learning group participation (operation 606).

The one or more LLAs 200 may respond with a confirmation (operation 607), upon which the ML orchestrator entity 100 may determine the ML job graph 400 (operation 608a) by either fetching the ML job graph 400 from for example a memory or a repository such as a NRF, or by computing a new ML job graph 400 otherwise.

Then, the ML orchestrator entity 100 may communicate to each LLA 200 the ML job information of each LLA 200 (operation 608b). The one or more LLAs 200 may then configure its process according to the ML job information (operation 609).

Once configured, the one or more LLAs 200 may jointly verify the performance of the ML model (operation 610) and may perform a forward pass (operation 611a). If an accuracy is greater than a preferred accuracy defined by the consumer, the aggregator LLA 300 may send the generated output o to the ML orchestrator entity 100 (operation 612), otherwise the one or more LLAs 200 may jointly update their partial functions through a backward pass (operation 611b).

The first interface 110 and the second interface 210 may be realized by means of a common bus. The common bus may connect all entities. The common bus may for example be a Service-Based Architecture (SBA) message bus of a 5G Core (5GC).

For example, in a case in which the ML orchestrator entity 100 may be instantiated in a NWDAF but some or all of the one or more LLAs 200 are RAN entities, such as gNBs, or UE entities, a method may be similar to that described above only changing interfaces.

For example, if the one or more LLAs 200 are RAN entities, the first interface may be realized as follows:
1) Using a common bus connecting all entities for example a SBA message bus of the 5GC to connect NWDAF with Access and Mobility Management Function (AMF).
2) Using the N2 interface between the AMF and the respective RAN entity.

For example, in a case in which the one or more LLAs are UEs, the first interface 110 may be realized similar to the case described above for RAN entities, but the second operation of the above two operations may be through a N1 interface.

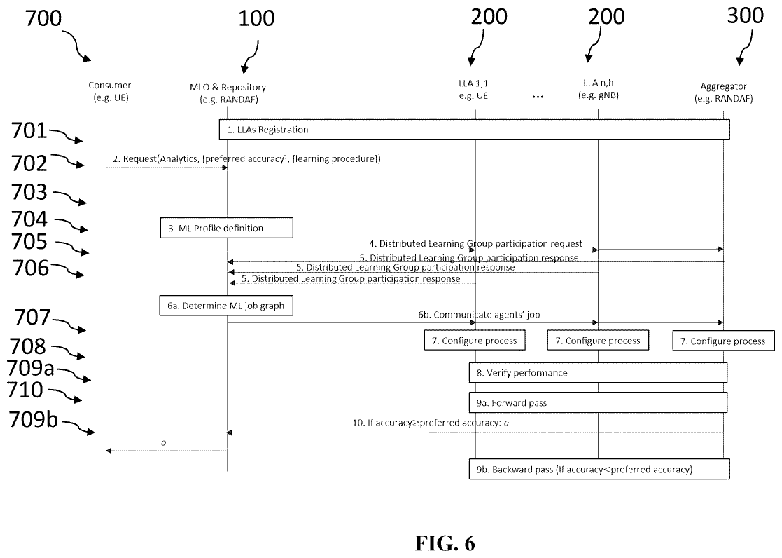

FIG. 6 illustrates a method 700 for message exchange between involved entities in a ML system 1000 according to an embodiment of this disclosure.

According to the example illustrated in FIG. 6 the ML system 1000 may comprise comprises a Radio Access Network (RAN) entity, for example a gNB or any other entity in the RAN such as a RAN Data Analytics Function (RANDAF) as the ML orchestrator entity 100 for a deployment in the RAN. In FIG. 6 the repository entity 303 may be within the ML orchestrator entity 100. A dedicated function similar to the NRF may also be possible. The one or more LLAs 200 may be UEs, other gNBs and/or RAN entity (e.g. RANDAF). The aggregator LLA 300 may either be the ML orchestrator entity 100, or another RAN entity such as a gNB or RANDAF. The consumer may be a UE, or any RAN entity such as a gNB or other RANDAF, and the consumer may also be part of the ML procedure in the form of an LLA.

The first interface 110 and the second interface 210 may for example be realized, in a case of a 5G system, by means of the Uu interface for gNB-UE pairs, by means of the Xn interface for gNB-gNB pairs, by means of interfaces defined to connect new RAN entities such as a RANDAF with a gNB for RANDAF-gNB pairs, and/or by means of the Uu interface and interfaces for RANDAF-gNB using the gNB as relay for UE-RANDAF pairs.

The method 700 may comprise one or more of the following operations:

First, the ML orchestrator entity 100 in FIG. 6 may register (operation 701) the one or more LLAs 200 in association with an analytics ID of the analytics service.

A NF in the form of a consumer may send an analytics service request to the ML orchestrator entity 100 (operation 702).

The ML orchestrator entity 100 in FIG. 6 may define a ML profile (operation 703), and may optionally send a request for a creation of a distributed learning group participation (operation 704).

The one or more LLAs 200 in FIG. 6 may respond with a confirmation (operation 705), upon which the ML orchestrator entity 100 may determine the ML job graph 400 (operation 706a) by either fetching the ML job graph 400 from for example a memory, or by computing a new ML job graph 400 otherwise.

Then, the ML orchestrator entity 100 in FIG. 6 may communicate to each LLA 200 the ML job information of each LLA 200 (operation 706b). The one or more LLAs 200 may then configure its process according to the ML job information (operation 707).

Once configured, the one or more LLAs 200 in FIG. 6 may jointly verify the performance of the ML model (operation 708) and may perform a forward pass (operation 709a). If an accuracy is greater than a preferred accuracy defined by the consumer, the aggregator LLA 300 may send the generated output o to the ML orchestrator entity 100 (operation 710), otherwise the one or more LLAs 200 may jointly update their partial functions through a backward pass (operation 709b).

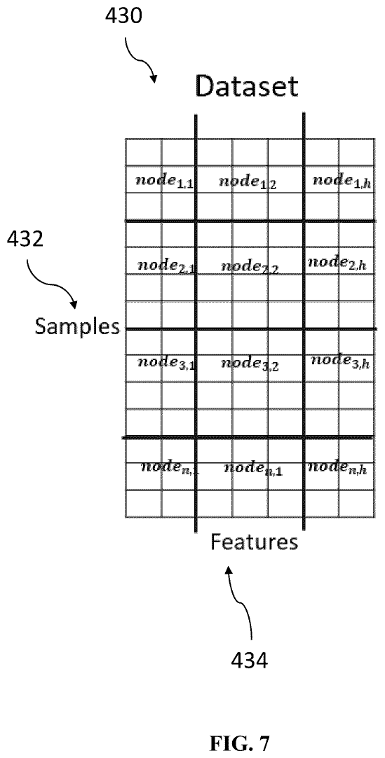

FIG. 7 illustrates the difference between a vertical data split and a horizontal data split according to an embodiment of this disclosure.

The vertical data split may be a feature-wise 434 split of a data set 430. The horizontal data split may be a sample-wise 432 split of a data set 430.

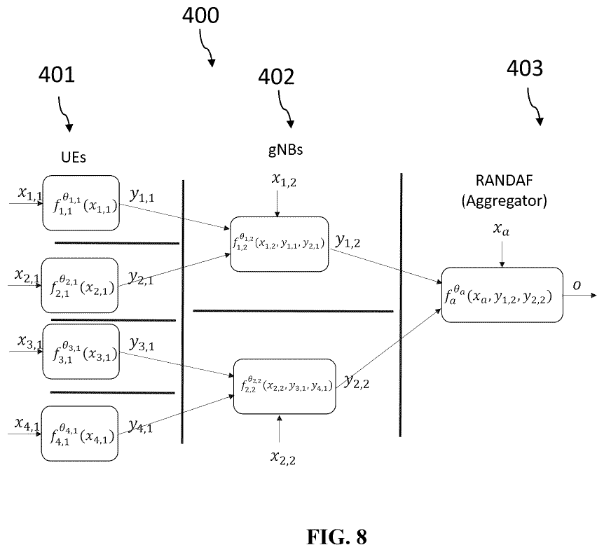

FIG. 7 illustrates an example that is based on quality of service (QOS) prediction related to the example illustrated in FIG. 8. The objective is to predict the QoS, such as throughput, that a UE may experience typically several seconds in advance. A critical issue for this particular task may be that the data set 430 may be distributed vertically among LLAs 200. The vertical data split shows that the features of samples in the data set 430 may be distributed among LLAs 200.

This may be seen in contrast to typical distributed analytics services such as FL, in which the data set 430 may be split horizontally. In the horizontal data split the data set 430 may be distributed among LLAs 200, but the features of each sample in the data set 430 may be located at the same LLA 200.

In the context of QoS prediction, such a vertical data split may appear from the fact that features of the samples may be available at different entities, and those entities may have privacy constraints with respect to that information. For example, typical features for the prediction of the throughput of a UE may be for example the location of the UE, the downlink signal to noise ratio (SNR), the location of the gNB to which the UE may be connected to, and uplink SNR, the cell load of gNB, the location of other UEs in the vicinity, the location of other gNBs causing interference to the UE, weather conditions, and/or the traffic profile.

Some of those features may be available at the UE (for example location UE and/or downlink SNR), others may be available at the gNB (for example location gNB, uplink SNR and/or cell load), or at other UEs in a vicinity (for example a location of another UE), or at other gNBs causing interference (for example location and/or transmit power), while the rest of the features, related to long-term information, may be located in a RAN entity such as a RANDAF (for example weather and/or traffic profile).

Table 1 shows a split of relevant features for a prediction of QoS of a UE, together with entities in which they may be available.

TABLE 1

| UEs | | | | gNBs | | | | | RANDAF | | | |
|---|---|---|---|---|---|---|---|---|---|---|---|---|
| Downlink | GPS | GPS | . . . | Uplink | Cell | GPS | GPS | . . . | Weather | Traffic | . . . | QoS |
| SNR | x | y | | SNR | load | x | y | | conditions | profile | | |

FIG. 8 illustrates a ML job graph 400 according to an embodiment of this disclosure.

The ML job graph 400 may be for predictive QoS among UEs and RAN entities. The ML job graph 400 in FIG. 8 may comprise four UEs, two gNBs and one RANDAF as aggregator LLA 300. In total FIG. 8 illustrates three levels: a UE level 401, a gNB level 402 and a RANDAF level 403. Since the ML job graph 400 may be distributed among seven entities, the AI/ML model, called θ, may be split in seven sets of parameters and corresponding functions. These parameters and corresponding functions may be θ={θ_{1,1}, θ_{1,2}, θ_{1,3}, θ_{1,4}, θ_{1,2}, θ_{2,2}, θₐ}, and the outputs from each LLA may be computed as y_{(i,j)}=f_{(i,j)}^{(θ_(i,j))} (x_{(i,j)}, . . . ).

The outputs of the UEs, that means y_{(1,1)}, y_{(2,1)}, y_{(3,1)}, y_{(4,1)} may be sent over the Uu interface to the corresponding gNB. The output of the gNBs may be sent to the RANDAF over the interfaces that connect the gNBs and the RANDAF.

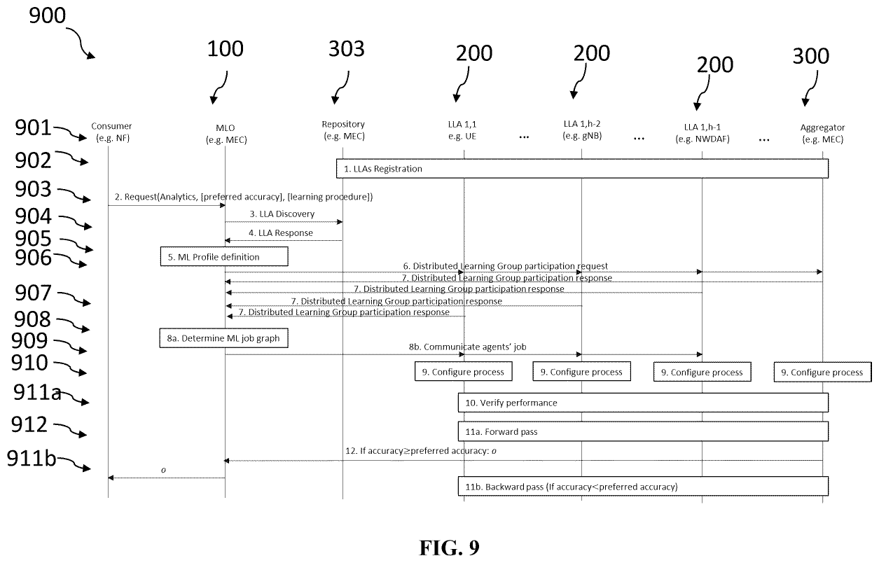

FIG. 9 illustrates a message exchange between involved entities in a ML system according to an embodiment of this disclosure.

In the example shown in FIG. 9 the ML orchestrator entity 100 may be located at a Multi-access Edge Computing (MEC) server, or any other server in a cloud. In this case, the repository entity 303 may be in the MEC. It may also be possible that the repository entity 303 may be in another MEC server or even within a 5GC such as in a NRF.

In this example, any message that needs to go from MEC to a function in a Core (core plane (CP) function, e.g., NWDAF) may be exchanged by means of an AF or Network Exposure Function (NEF) reachable by the MEC. Any message between the MEC and the RAN entity such as a gNB or RANDAF may be realized over an AMF through a service-based architecture (SBA) bus and/or N2 interfaces, or alternatively over an User Plane Function (UPF) using N3 and N6 interfaces. Any message between MEC and UE may be realized over the AMF through the SBA bus and N1 interfaces, or alternatively over the UPF using N6, N3 and Uu interfaces.

The method 900 may comprise one or more of the following operations:

First, the ML orchestrator entity 100 may register (operation 901) the one or more LLAs 200 in association with an analytics ID of the analytics service.

After a NF in the form of a consumer sends an analytics service request to the ML orchestrator entity 100 (operation 902), the ML orchestrator entity 100 may contact the repository entity 303 for LLA discovery (operation 903).

The Repository may reply with a discovery response including information regarding available LLAs 200, their data, and their constraints (operation 904).

With this information, the ML orchestrator entity 100 may define a ML profile (operation 905), and may optionally send a request for a creation of a distributed learning group participation (operation 906).

The one or more LLAs 200 may respond with a confirmation (operation 907), upon which the ML orchestrator entity 100 may determine the ML job graph 400 (operation 908a) by either fetching the ML job graph 400 from for example a memory, or by computing a new ML job graph 400 otherwise.

Then, the ML orchestrator entity 100 may communicate to each LLA 200 the ML job information of each LLA 200 (operation 908b). The one or more LLAs 200 may then configure its process according to the ML job information (operation 909).

Once configured, the one or more LLAs 200 may jointly verify the performance of the ML model (operation 910) and may perform a forward pass (operation 911a). If an accuracy is greater than a preferred accuracy defined by the consumer, the aggregator LLA 300 may send the generated output to the ML orchestrator entity 100 (operation 912), otherwise the one or more LLAs 200 may jointly update their partial functions through a backward pass (operation 911b).

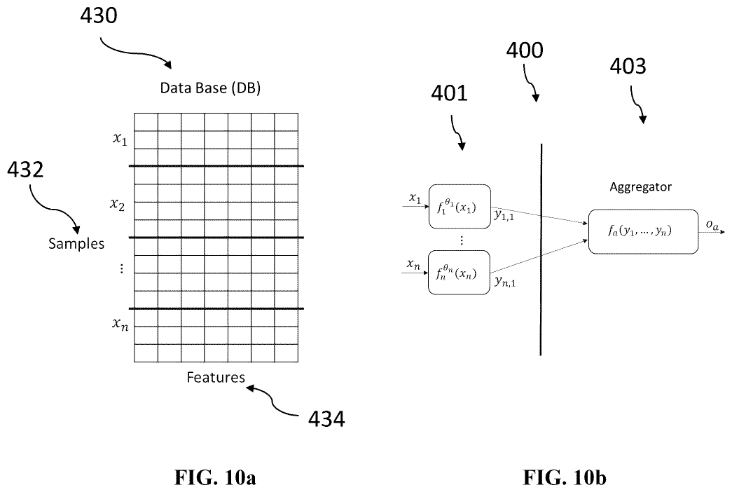

FIG. 10a shows a horizontal data split according to an embodiment of this disclosure.

This example illustrates the applicability of the ML system 1000 to non-differentiable learning methods such as RF. The ML job graph 400 for executing a Tree-based algorithm considering a horizontal data split in a distributed manner may be similar to that of a federated learning under the same conditions.

FIG. 10b illustrates a ML job graph 400 according to an embodiment of this disclosure.

The ML job graph 400 illustrated in FIG. 10b for a random forest based analytics service may comprise one or more LLAs 200 and one aggregator LLA 300. In total there may be two or more levels. Each LLA 200 based on an available local data set may generate a random forest and, may store and/or may forward and output and/or associated parameters to the next node, as informed by the ML orchestrator entity 100. Parameters at one or more LLAs 200 may include, but are not limited to, a tree index, a number of trees, a node splitting criteria, a rule for node splitting, a threshold for node splitting, a leaf node size, a performance metric for each tree, a method to determine a final ensemble output, a subset of trees and/or parameters to be considered at the next level. Since the ML job graph 400 may be distributed among several LLAs 200, the parameters from multiple LLAs, i.e. {y_{1,1}, . . . , y_{(n,1)}} may be combined at the aggregator LLA 300 to determine a global model which may be further used by the one or more LLAs 200.

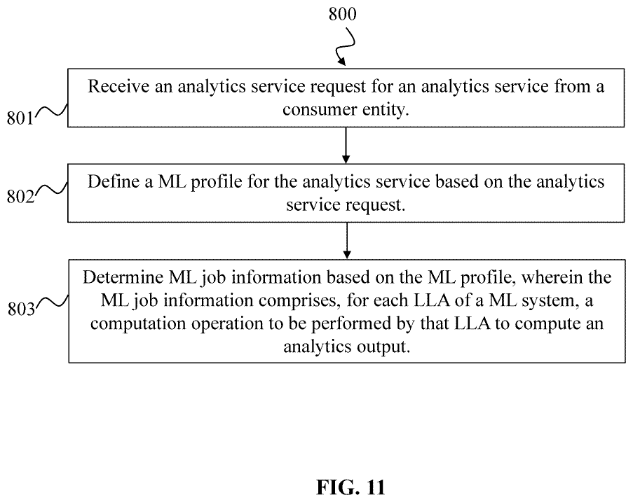

FIG. 11 shows a method 800 for a ML orchestrator entity 100 according to an embodiment of this disclosure. The method 800 may be used for a ML system 1000 comprising one or more LLAs 200. The one or more LLAs 200may be configured to compute an analytics output for an analytics service. The method 800 may be performed by the ML orchestrator entity 100.

The method 800 comprises an operation 801 of receiving an analytics service request for the analytics service from a consumer entity.

The method 800 also comprises an operation 802 of defining a ML profile for the analytics service based on the analytics service request.

The method 800 further comprises an operation 803 of determining ML job information based on the ML profile, wherein the ML job information indicates, for each LLA 200 of the ML system 1000, a computation operation to be performed by that LLA 200 to compute the analytics output.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or operations and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A machine learning (ML) orchestrator entity for a ML system comprising one or more local learning agents (LLAs) configured to jointly compute an analytics output for an analytics service, wherein the ML orchestrator entity comprises first processing circuitry configured to:
receive an analytics service request for the analytics service from a consumer entity;
define a ML profile for the analytics service based on the analytics service request; and
determine ML job information based on the ML profile, wherein the ML job information comprises, for each LLA of the one or more LLAs, a computation operation to be performed by that LLA to compute the analytics output.

2. The ML orchestrator entity according to claim 1, wherein
the first processing circuitry is configured to define the ML profile for the analytics service further based on one or more LLA constrains.

3. The ML orchestrator entity according to claim 1, wherein
the ML job information comprises interface configuration information, wherein the interface configuration information indicates
from which LLA of the one or more LLAs each LLA of the one or more LLAs is configured to receive a partial analytics output, and
to which LLA of the one or more LLAs each LLA of the one or more LLAs is configured to send a partial analytics output.

4. The ML orchestrator entity according to claim 1, wherein
the ML orchestrator entity is further configured to determine if the ML job information for the ML profile already exists, and
in response to the ML job information exists, the ML orchestrator entity is configured to retrieve the existing ML job information, and
in response to the ML job information does not exist, the ML orchestrator entity is configured to create the ML job information based on the ML profile.

5. The ML orchestrator entity according to claim 1, wherein
the ML orchestrator entity is configured to communicate to each LLA of the one or more LLAs information indicating the computation operation to be performed by that LLA according to the ML job information.

6. The ML orchestrator entity according to claim 1, wherein
the ML orchestrator entity is configured to compute a ML job graph as the ML job information, wherein the ML job graph defines a set of parameters and corresponding functions related to the computation operation for each LLA of the ML system.

7. The ML orchestrator entity according to claim 1, wherein
the ML orchestrator entity is configured to collaborate with the one or more LLAs to compare a performance of the analytics output for the analytics service with an expected performance.

8. The ML orchestrator entity according to claim 7, wherein
the ML orchestrator entity is configured to determine based on the compared performance whether a training or a retraining of the ML profile is needed, and to redefine the ML profile for the analytics service if the training or the retraining is needed.

9. The ML orchestrator entity according to claim 1, wherein
the analytics service request from the consumer entity comprises at least one of an analytics ID of the analytics service, or a requested ML model accuracy for the analytics service, or a requested ML technique for the analytics service.

10. The ML orchestrator entity according to claim 1, wherein the ML orchestrator entity is further configured to:
trigger a training operation or a retraining operation of a ML model of the ML profile at one or more of the one or more LLAs for the analytics service based on at least one of the following information:
one or more LLA IDs, each LLA ID indicating a LLA for computing their analytics output for the analytics service;
a type of the analytics service;
an expected analytics performance based on a requested ML model accuracy;
a preferred ML technique for computing the analytics output; or
data available at the one or more LLAs.

11. The ML orchestrator entity according to claim 1, wherein
the ML orchestrator entity is further configured to register the one or more LLAs in association with an analytics ID of the analytics service, wherein the ML orchestrator entity is configured to receive a registration message from each LLA of the one or more LLAs, the registration message comprising at least one of the following information:
a LLA ID of the LLA,
data available at the LLA, or
one or more constraints of the LLA.

12. A local learning agent (LLA), for a machine learning (ML) system, the LLA comprising second processing circuitry configured to:
receive ML job information indicating a computation operation to be performed by the LLA;
perform the computation operation based on the received ML job information to compute an analytics output for an analytics service; and
output the analytics output to a ML orchestrator entity or another LLA.

13. The LLA according to claim 12, wherein the LLA is further configured to:
train or retrain a ML model of a ML profile for the analytics service based on at least one of the following information:
one or more LLA IDs, each LLA ID indicating a LLA for computing their analytics output for the analytics service;
a type of the analytics service;
an expected analytics performance based on a requested ML model accuracy;
a preferred ML technique for computing the analytics output; or
local input available at the one or more LLAs.

14. The LLA according to claim 12, wherein
the LLA is configured to determine based on a compared performance whether a retraining of a ML profile defined by the ML orchestrator entity is needed, and inform the ML orchestrator entity accordingly.

15. The LLA according to claim 12, wherein
the LLA is configured to receive one or more inputs from other LLAs, each input comprising a partial analytics output for the analytics service; or
the LLA is configured to compute its partial analytics output further based on one or more local inputs.

16. A method for a machine learning (ML) orchestrator entity for a ML system comprising one or more local learning agents (LLAs), configured to compute an analytics output for an analytics service, the method being performed by the ML orchestrator entity and comprising:
receiving an analytics service request for the analytics service from a consumer entity;
defining a ML profile for the analytics service based on the analytics service request; and
determining ML job information based on the ML profile, wherein the ML job information comprises, for each LLA of the ML system, a computation operation to be performed by that LLA to compute the analytics output.
